(19) United States
(12) Patent Application Publication
(10) Pub. No.: US 2010/0097706 A1
(43) Pub. Date: Apr. 22, 2010

(54) Optical sheet

(75) Inventors: Whey-Bin LOR, Jhubei City (TW); Kuang-Lin YUAN, Taichung City (TW); Chia-Chu LIN, Dongshan Township (TW)

Correspondence Address: HOLLAND & HART, LLP, P.O BOX 8749, DENVER, CO, 80201, US

(73) Assignee: Optivision Technology, Inc., Hsinchu (TW)

(21) Appl. No.: 12/383,398

(22) Filed: Mar. 24, 2009

(30) Foreign Application Priority Data
Oct. 21, 2008 (TW) 097218788

(51) Int. Cl. G02B 5/02

(52) U.S. Cl. 359/599

(57) ABSTRACT

An optical sheet is adapted for diffusing and converging light, and includes a light-transmissive base layer, a prism layer, and a plurality of diffusion regions. The base layer has a first surface and a second surface that is opposite to the first surface. The prism layer is provided on the first surface of the base layer and has a plurality of prisms, each of which has a peak and two inclined surfaces that meet at the peak. At least two of the peaks of the prisms are different in height. The diffusion regions are disposed on the inclined surfaces of the prisms. Each of the diffusion regions is in the form of a roughened surface.

### CROSS-REFERENCE TO RELATED APPLICATION

This application claims priority of Taiwanese application no. 097218788, filed on Oct. 21, 2008.

### BACKGROUND OF THE INVENTION

1. Field of the Invention

This invention relates to an optical sheet, more particularly to an optical sheet adapted for diffusing and converging light.

2. Description of the Related Art

Referring to FIG. 1, a conventional backlight module 9 includes a light source 91, a light guide plate 92, a reflector plate 93 that is disposed on a first surface of the light guide plate 92, a first diffusion sheet 95 that is disposed on a second surface of the light guide plate 92, a second diffusion sheet 96, and a prism sheet 94 that is disposed between the first and second diffusion sheets 95, 96. Light can be uniformly spread by means of the first and second diffusion sheets 95,96. The prism sheet 94 is capable of refracting light, thereby further converging the same. Light rays emitted from the light source 91 are directed into the first diffusion sheet 95 by virtue of the light guide plate 92. Sequentially, the light rays are scattered from the first diffusion sheet 95, refracted via the prism sheet 94, and scattered from the second diffusion sheet 96. Some of the light rays emitted from the light source 91 are reflected toward the light guide plate 92 by the first diffusion sheet 95, the prism sheet 94, or the second diffusion sheet 96. Nevertheless, the reflector plate 93 can be applied to reflect the light rays that are reflected by the first diffusion sheet 95, the prism sheet 94, or the second diffusion sheet 96 back to the first diffusion sheet 95.

Referring to FIG. 2, the prism sheet 94 has a plurality of prisms 941 that extend longitudinally, that are equal in size, and that are parallel to each other. Chromatic dispersion is induced due to the prisms 941. When a great amount of the prisms 941 equal in size are disposed together, rainbows are easily produced and obviously observed at a specific angle. If the prism sheet 94 were solely and directly disposed on the second surface of the light guide plate 92 for constructing a backlight module (i.e., the first and second diffusion sheets 95, 96 were not used), possible defects, such as undesired exposure of dot patterns, flaws, and Newton's rings, might be generated. In other words, the prism sheet 94 is unable to hide the aforementioned defects. Therefore, the first and second diffusion sheets 95, 96 are required for the conventional backlight module 9 in order to uniformly spread light and prevent occurrence of the aforementioned defects.

However, a thickness of the backlight module 9 is large owing to presence of the first and second diffusion sheets 95, 96, thereby lowering transmittance of light. Furthermore, a process of assembling the first diffusion sheet 95, the prism sheet 94, and the second diffusion sheet 96 is time-consuming, and may lower a production yield of the backlight module 9 and increase a production cost of the same.

### SUMMARY OF THE INVENTION

The object of the present invention is to provide an optical sheet that can overcome the aforesaid drawbacks of the prior art.

According to this invention, an optical sheet is adapted for diffusing and converging light, and includes a light-transmissive base layer, a prism layer, and a plurality of diffusion regions. The base layer has a first surface and a second surface that is opposite to the first surface. The prism layer is provided on the first surface of the base layer and has a plurality of prisms, each of which has a peak and two inclined surfaces that meet at the peak. At least two of the peaks of the prisms are different in height. The diffusion regions are disposed on the inclined surfaces of the prisms. Each of the diffusion regions is in the form of a roughened surface.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a schematic view of a conventional backlight module;

FIG. 2 is a fragmentary perspective view of a prism sheet of the conventional backlight module;

FIG. 3 is a fragmentary perspective view of the first preferred embodiment of an optical sheet according to this invention;

FIG. 4 is a fragmentary side view of the first preferred embodiment;

FIG. 5 is a fragmentary side view of the second preferred embodiment of the optical sheet according to this invention;

FIG. 6 is a fragmentary side view of the third preferred embodiment of the optical sheet according to this invention; and

FIG.7 is a fragmentary side view of the fourth preferred embodiment of the optical sheet according to this invention.

### DETAILED DESCRIPTION OF THE PREFERRED EMBODIMENTS

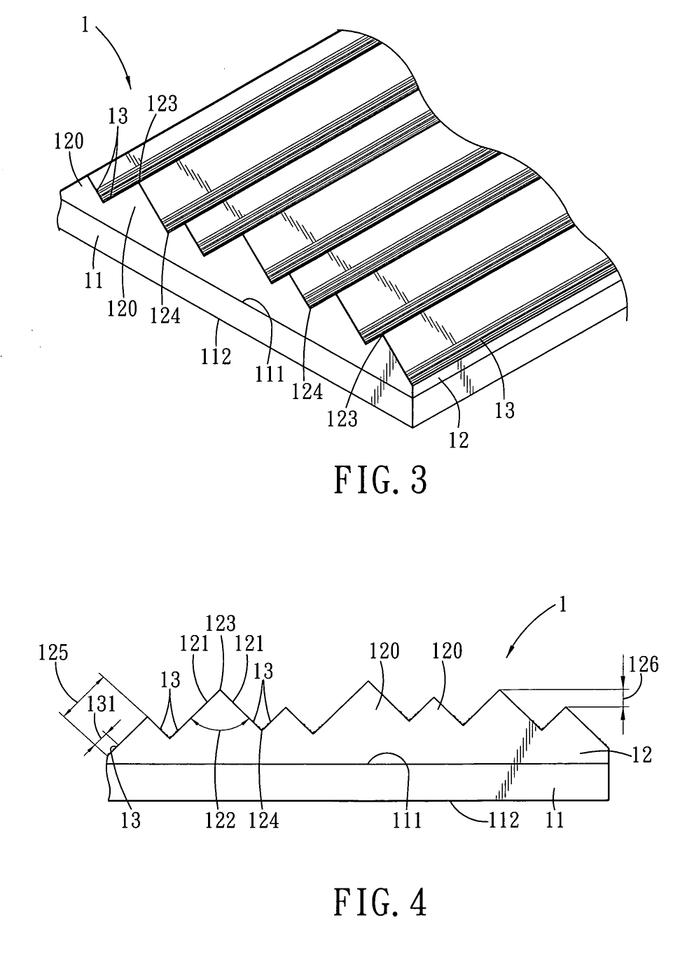

Before the present invention is described in greater detail, it should be noted that FIGS. 3, 4, 5, 6, and 7 are not drawn to scale for the sake of convenience and that the same reference numerals have been used to denote like elements throughout the specification.

Referring to FIGS. 3 and 4, the first preferred embodiment of an optical sheet 1 according to the present invention is adapted for diffusing and converging light, and includes a light-transmissive base layer 11, a prism layer 12, and a plurality of diffusion regions 13.

The base layer 11 has a first surface 111 and a second surface 112 that is opposite to the first surface 111. Examples of materials that can be used for producing the base layer 11 are polycarbonate (PC), polyethylene terephthalate (PET), and so forth. Light is able to enter the base layer 11 through the second surface 112 and to exit the base layer 11 via the first surface 111. The prism layer 12 is provided on the first surface 111 of the base layer 11 and has a plurality of prisms 120, each of which extends longitudinally on the first surface 111, and has a peak 123 and two inclined surfaces 121 that meet at the peak 123. The peaks 123 of the prisms 120 are different in height. A height difference 126 between the peaks 123 of the prisms 120 ranges from 0.5 to 40 μm. In other words, the height difference 126 between any two of the peaks 123 is not less than 0.5 μm. The height difference 126 between the highest peak 123 and the lowest peak 123 is not greater than 40 μm. It is noted that some of the peaks 123 of the prisms 120 can be equal in height, but any two of the prisms 120 having the peaks 123 equal in height are preferably spaced apart with an appropriate distance.

Preferably, each of the prisms 120 defines an angle 122 of 90° to 110° at a respective one of the peaks 123. When the angle 122 is increased, a wider viewing angle and lower luminance are induced. In this embodiment, the angle 122 is about 90°. Each of the inclined surfaces 121 of each of the prisms 120 is joined to one of the inclined surfaces 121 of the other one of the prisms 120 along a foot line 124. Each of the two inclined surfaces 121 of each of the prisms 120 has a width 125 that is defined by a distance between a respective one of the peaks 123 of the prisms 120 and a respective one of the foot lines 124 of the prisms 120.

The diffusion regions 13 are disposed on the inclined surfaces 121 of the prisms 120. In particular, each of the two inclined surfaces 121 of each of the prisms 120 has a portion provided with one of the diffusion regions 13. Each of the diffusion regions 13 is in the form of a roughened surface, is adjacent to a respective one of the foot lines 124, extends longitudinally as a strip in the same direction as the prisms 120, and has a width 131 that is substantially equal to 2 to 90 percent of the width 125 of a respective one of the inclined surfaces 121. The higher the percentage of the width of the diffusion region 13, the lower the capability to hide defects. The lower the percentage of the diffusion region 13, the higher the effect to increase luminance. Preferably, some of the diffusion regions 13 respectively have the width 131 that is nearly equal to 33 to 50 percent of the width 125 of the respective inclined surfaces 121, and some of the diffusion regions 13 respectively have the width 131 that is approximately less than 10 percent of the width 125 of the respective inclined surfaces 121. The diffusion regions 13 with the larger widths 131 and the diffusion regions 13 with the smaller widths 131 are alternately disposed on the inclined surfaces 121 of the prisms 120. The roughened surface of each of the diffusion regions 13 is formed by virtue of an engraving machine and has a roughness that ranges from 0.1 to 3 μm.

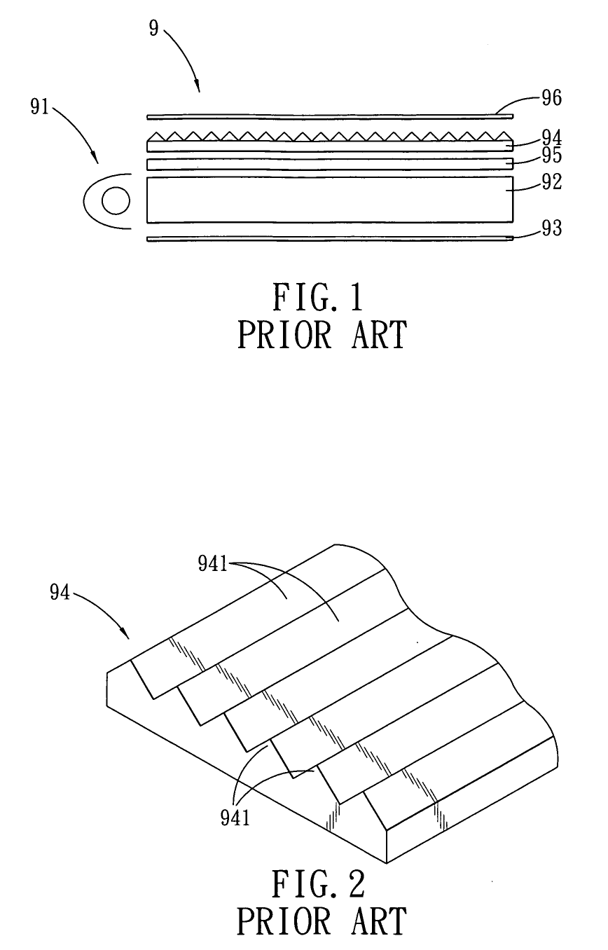

Each of the inclined surfaces 121 has a smooth portion that is not provided with the diffusion region 13. The optical sheet 1 is able to refract and converge light via the smooth portions of the inclined surfaces 121. Mixing of blue, green, and red light rays that are produced due to chromatic dispersion of the prisms 120 can be enhanced by virtue of the height difference 126 between the peaks 123 of the prisms 120, thereby lowering the possibility of forming rainbows at a specific angle. The roughened surfaces of the diffusion regions 13 produce haze in the prisms 120 and scatter light, thereby lowering the phenomenon of chromatic dispersion. When the optical sheet 1 is applied to a backlight module (not shown), in addition to reduction of chromatic dispersion and generation of haze, the phenomenon of Newton's rings that arises from interference between optical sheets (not shown) of the backlight module can be decreased, and the flaws in the backlight module can be effectively shielded and hidden. Consequently, the optical sheet 1 of the present invention has functions of both of the prism sheet 94 and the second diffusion sheet 96, which are used in the prior art shown in FIG. 1.

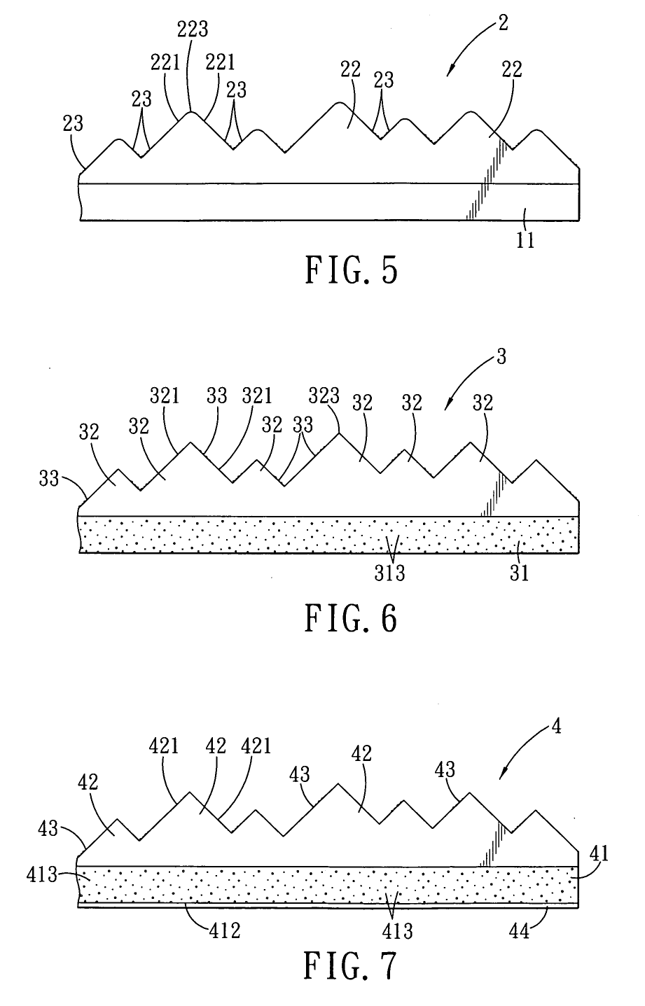

Referring to FIG. 5, the second preferred embodiment of the optical sheet according to this invention is shown at 2. The structure of this preferred embodiment is generally similar to the structure of the first preferred embodiment. The difference between this preferred embodiment and the first preferred embodiment resides in that the peak 223 of each of the prisms 22 is rounded and has a radius of curvature, which ranges from 2 to 15 μm. The rounded peaks 223 are able to increase wear-resistance and scratch resistance of the optical sheet 2, and a viewing angle. When the radius of curvature of each of the peaks 223 is increased, a wider viewing angle and lower luminance are induced. The diffusion regions 23 are disposed on the prisms 22 in the same manner as that of the first preferred embodiment.

Referring to FIG. 6, there is shown an optical sheet 3 according to the third preferred embodiment of this invention. The structure of this preferred embodiment is generally similar to the structure of the first preferred embodiment. The difference between this preferred embodiment and the first preferred embodiment is described as follows. The base layer 31 has a plurality of diffusion particles 313 so as to induce haze. Examples of materials that can be used for producing the diffusion particles 313 are polymethylmethacrylate (PMMA), polystyrene (PS), titanium dioxide (TiO₂), silicon dioxide (SiO₂), and so forth. The diffusion regions 33 are randomly disposed on the inclined surfaces 321 of the prisms 32.

The base layer 31 has a haze factor that ranges from 10 to 90 percent, and is capable of uniformly scattering light by virtue of the diffusion particles 313. Thus, the base layer 31 can be used for replacing the first diffusion sheet 95 (shown in FIG. 1) of the conventional backlight module 9 (shown in FIG. 1). When the haze factor of the base layer 31 is increased, more efficient scattering of light and lower transmittance of light are achieved. On the other hand, less efficient scattering of light and higher transmittance of light are reached by way of decreasing the haze factor of the base layer 31. The base layer 31 having such a hazy property is available in the market. Since the feature of the invention does not reside in the base layer 31 having the haze factor, further details of the same are omitted herein for the sake of brevity.

Like the previous embodiments, each of the diffusion regions 33 in this embodiment is provided on a portion of one of the inclined surfaces 321. However, some prisms 32 have the diffusion regions 33 on both of the inclined surfaces 321 thereof, and some prisms 32 have the diffusion regions 33 on only one of the inclined surfaces 321 thereof. The diffusion regions 33 are disposed on different locations of the inclined surfaces 321. Preferably, each of the diffusion regions 33 is disposed away from a respective one of the peaks 323 with an appropriate distance. Reduction of chromatic dispersion and uniform light scattering can still be achieved via the diffusion regions 33 that are randomly disposed on the inclined surfaces 321. The optical sheet 3 in the third preferred embodiment has functions of all of the prism sheet 94, the first diffusion sheet 95, and the second diffusion sheet 96 of the prior art shown in FIG. 1.

Referring to FIG. 7, the fourth preferred embodiment of the optical sheet according to this invention is shown at 4. The structure of this preferred embodiment is generally similar to the structure of the first preferred embodiment. The difference between this preferred embodiment and the first preferred embodiment is described as follows. The base layer 41 has a plurality of the diffusion particles 413 to produce haze like the base layer 31 of the third preferred embodiment. The optical sheet 4 further includes a diffusion layer 44 provided on the second surface 412 of the base layer 41. Only one of the two inclined surfaces 421 of each of the prisms 42 has a portion provided with one of the diffusion regions 43.

In this embodiment, a UV curable resin is applied to the second surface 412 of the base layer 41, and is subsequently exposed to UV light to cure and form the diffusion layer 44 having a roughened surface. The roughened surface of the diffusion layer 44 is able to assist the base layer 41 in scattering light, and to protect the second surface 412 of the base layer 41 from being scratched. When the optical sheet 4 is used in a backlight module (not shown), the base layer 41 is prevented from being adhered to a light guide plate (not shown) of the backlight module by an electrostatic attraction force such that a wet-out phenomenon is not induced. It is noted that the diffusion layer 44 can be applied to the non-hazy base layer 11 in the first and second preferred embodiments.

Referring to FIGS. 1 to 7, it should be noted that the present invention is not limited to the preceding preferred embodiments. For example, the location of the diffusion region 13, 23, 33, 43 on the inclined surface 121, 221, 321, 421 may be altered as desired. In another example, the base layer 41 in the fourth preferred embodiment can be utilized in place of the base layer 11 in the first and second preferred embodiments. In yet another example, the diffusion layer 44 in the fourth preferred embodiment can be coated on the base layer 31 in the third preferred embodiment.

According to the invention, the second diffusion sheet 96 of the conventional backlight module 9 may be dispensed with when the optical sheet 1, 2, 3, 4 is applied to a backlight module (not shown). When the base layers 31, 41 of the third and fourth preferred embodiments are used, the first diffusion sheet 95 used in the conventional backlight module 9 may be dispensed with. Therefore, with the use of the optical sheet 1, 2, 3, 4 of the present invention, a backlight module (not shown) having a small thickness can be produced. Time for assembling the backlight module is reduced as well. Furthermore, a higher production yield of the backlight module and a lower cost of production of the same are achieved.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. An optical sheet adapted for diffusing and converging light, said optical sheet comprising:
a light-transmissive base layer having a first surface and a second surface that is opposite to said first surface;
a prism layer provided on said first surface of said base layer and having a plurality of prisms, each of which has a peak and two inclined surfaces that meet at said peak, at least two of said peaks of said prisms being different in height; and
a plurality of diffusion regions that are disposed on said inclined surfaces of said prisms, each of said diffusion regions being in the form of a roughened surface.

2. The optical sheet as claimed in claim 1, wherein at least one of said two inclined surfaces of each of said prisms has a portion provided with one of said diffusion regions.

3. The optical sheet as claimed in claim 2, wherein each of said two inclined surfaces of each of said prisms has a portion provided with one of said diffusion regions.

4. The optical sheet as claimed in claim 1, wherein said prisms extend longitudinally on said first surface, each of said diffusion regions extending longitudinally as a strip in the same direction as said prisms.

5. The optical sheet as claimed in claim 4, wherein:
each of said inclined surfaces of each of said prisms is joined to one of said inclined surfaces of the other one of said prisms along a foot line;
each of said two inclined surfaces of each of said prisms has a width that is defined by a distance between a respective one of said peaks of said prisms and a respective one of said foot lines of said prisms; and
each of said diffusion regions has a width that is substantially equal to 2 to 90 percent of said width of a respective one of said inclined surfaces.

6. The optical sheet as claimed in claim 5, wherein said width of each of said diffusion regions is substantially equal to 2 to 50 percent of said width of the respective one of said inclined surfaces.

7. The optical sheet as claimed in claim 5, wherein each of said diffusion regions is adjacent to a respective one of said foot lines.

8. The optical sheet as claimed in claim 1, wherein said roughened surface of each of said diffusion regions has a roughness that ranges from 0.1 to 3 μm.

9. The optical sheet as claimed in claim 1, wherein a height difference between said peaks of said prisms ranges from 0.5 to 40 μm.

10. The optical sheet as claimed in claim 1, wherein each of said prisms defines an angle of 90° to 110° at a respective one of said peaks.

11. The optical sheet as claimed in claim 1, wherein said peak of each of said prisms is rounded and has a radius of curvature, which ranges from 2 to 15 μm.

12. The optical sheet as claimed in claim 1, wherein said base layer has a haze factor that ranges from 10 to 90 percent.

13. The optical sheet as claimed in claim 1, further comprising a diffusion layer provided on said second surface of said base layer.
